(19) United States
(12) Patent Application Publication
(10) Pub. No.: US 2004/0175476 A1
(43) Pub. Date: Sep. 9, 2004

(54) Methods for reducing meat discoloration

(76) Inventor: Robert D. Kross, Bellmore, NY (US)

Correspondence Address: Henry D. Coleman, 714 Colorado Avenue, Bridgeport, CT, 06605-1601, US

(21) Appl. No.: 10/791,319

(22) Filed: Mar. 2, 2004

Related U.S. Application Data
(60) Provisional application No. 60/452,114, filed on Mar. 6, 2003.

(51) Int. Cl. A23K 1/00

(52) U.S. Cl. 426/532

(57) ABSTRACT

The invention provides methods comprising applying an aqueous solution comprising a reducing agent to meat disinfected with an oxidizing germicide, wherein application of the aqueous solution to the meat reduces meat discoloration caused by the oxidizing germicide.

### RELATED APPLICATIONS

This application claims the benefit of provisional application No. 60/452,114, entitled “Ameliorating Tissue Discoloration Caused by Meat-Processing Oxidative Antimicrobial Agents”, filed Mar. 6, 2003, the entire contents of which is incorporated by reference herein.

### FIELD OF THE INVENTION

The invention provides methods comprising applying an aqueous solution comprising a reducing agent to meat disinfected with an oxidizing germicide, wherein application of the aqueous solution to the meat reduces meat discoloration caused by the oxidizing germicide.

### BACKGROUND OF THE INVENTION

The surfaces of freshly slaughtered and eviscerated poultry and other meats are contaminated with microorganisms that are present on the animals' skins, hides, feathers and hair from fecal contact from both the animal itself and nearby animals, as well as by physical transfer from the animals' viscera through contact with processing equipment. The bacteria of greatest concern are pathogens such as Salmonella and Campylobacter species, Escherichia coli, including the particularly virulent strain 0157:H7, Listeria monocytogenes and other harmful enterobacteriaceae. Many of these organisms can survive carcass scalding temperatures of 50° C. to 58° C., and thereafter cross-contaminate other carcasses on the processing line. This is true also for the so-called “spoilage organisms,” where excessive levels of the psychotropic and lactic acid bacteria will reduce the shelf-life of the final processed poultry and meat products by proliferating to a level where odor and textural qualities make the meat products unacceptable to the consumer.

A number of disinfecting agents have been used during the processing of animal carcasses and parts to reduce or eliminate undesired microorganisms, including pathogens and spoilage organisms. These agents are generally applied during one or several stages of the carcass processing, as well as on subsequent subdivided sections. For poultry, this would correspond to 1) post defeathering, eviscerating and water-washing of the carcass and immediately prior to chiller-tank immersion, 2) in the chiller tank itself, and 3) on subsequent parts and/or the packaged products. During the processing of mammalian carcasses, application of antimicrobial agents would generally occur after skinning and washing of carcass halves, and subsequently to subdivided portions, including prior to comminution if such occurs. The agents in current use include trisodium phosphate, chlorine dioxide, peracetic acid, ozone, radiation, chlorine, cetyl pyridinium chloride, acidified sodium chlorite(chlorous acid), and organic acids such as lactic and acetic. Another promising technology, in early stages of development, is acidified sodium nitrite (nitrous acid).

Such agents can be classified as one of two major types, a) oxidizing agents, and b) non-oxidizing agents. Included in a) are chlorine, chlorine dioxide, peracetic acid, ozone, acidified sodium chlorite and acidified sodium nitrite. In general, these agents act by destroying specific sites on microorganisms, and thereby inactivating or totally-destroying them. The non-oxidants eliminate undesired organisms through a variety of effects, from facilitated physical removal (trisodium phosphate) to the actual destruction of the contaminating species. Oxidizing antimicrobial agents useful in meat and poultry processing are disclosed in U.S. Pat. Nos. 5,389,390; 6,063,425; 4,021,585; 4,362,753 and 3,745,026.

When used for such processing, the oxidizing antimicrobials can often produce undesired color and textural effects of the disinfected tissue, and even off-flavor development. Specifically, oxidants can convert the red hemoglobin, in the surface tissue of the poultry or meat, to brown methemoglobin. In addition, there can be oxidation and bleaching of carotenoid colorants in poultry fat, and selective oxidation of specific amino acids, (such as tyrosine and tryptophan) in animal proteins, to form colored species. For example, chicken skin can become lighter and change from its normal pinkish white appearance to a grayish-white. Other visual changes can include brown areas, and bleached or old-looking carcasses. The resulting discoloration has a marked impact on the desire of animal food processors to use such antimicrobial agents, despite their beneficial disinfection. For example, U.S. Pat. No. 4,362,753 cited above employs chlorine dioxide at lower levels than the previous teaching, specifically to minimize tissue discoloration, but with the inherent potential for minimized efficacy. As a result of this negative organoleptic effect there is a need by processors, who use these agents, to reduce the contact time and/or the concentration of the particular oxidizing antimicrobial agent, so as to minimize hemoglobin discoloration and bleaching, while preserving some of the antimicrobial activity. Were it not for this limitation caused by tissue discoloration, processors could use these, agents at higher concentrations and/or for greater contact times, to further reduce unwanted food pathogens, such as E. coli, Listeria and Salnonella on the meat or poultry surfaces.

Accordingly, the need exists for improved methods for reducing or eliminating undesired discoloration caused by oxidizing disinfectants during meat processing.

### OBJECTS OF THE INVENTION

It is an object of the present invention to provide a method for improving meat disinfection processes and the quality of resultant food products.

It is a further object of the invention to provide a method for minimizing undesired tissue effects caused by exposure of meat products to oxidizing disinfecting agents during processing.

It is a further object of the invention to enhance the disinfecting capability of oxidizing disinfectants by facilitating longer contact times and/or higher concentrations of disinfectants by minimizing undesired tissue effects.

### SUMMARY OF THE INVENTION

The invention provides methods comprising applying an aqueous solution comprising a reducing agent to meat disinfected with an oxidizing germicide, wherein application of the aqueous solution to the meat reduces meat discoloration caused by the oxidizing germicide. Aqueous solutions comprising a reducing agent are applied at an appropriate time interval following application to the meat of the oxidizing germicide so as to suppress undesired tissue effects of the oxidants with minimal interference of its germicidal action.

It is important to apply the aqueous solution comprising the reducing agent to the meat surface within a certain time period after the meat has been treated with the oxidizing germicide because the oxidizing germicide acts relatively rapidly. More specifically, the aqueous solution comprising the reducing agent should be applied to the meat surface within about five seconds to about one hour after the meat has been treated with the oxidizing germicide.

The reducing agent must be acceptable for use in foodstuffs. For example, food-grade materials as Vitamin C (ascorbic acid), ascorbic acid salts such as sodium or calcium ascorbate, ascorbic acid esters such as ascorbyl palmitate, erythorbic acid, sodium or potassium bisulfite, sodium or potassium metabisulfite, and sodium thiosulfate will either prevent or significantly mitigate tissue discoloration. The aqueous solution comprising the reducing agent may be sprayed onto the meat. Alternatively, the meat may be immersed into the aqueous solution comprising the reducing agent at an appropriate time period after the meat has been exposed to the oxidizing germicide by either spray or dip application.

The period of time between application of germicide and neutralizer, as well as the concentration of the reducing agent solution, depends on many factors. These include the nature of the germicide, its concentration, whether application is by spray or dip, the animal species involved, residence time of the germicide on the tissue, and temperature of the tissue.

It is preferable that the germicide-treated meat be subjected to a water wash, either by spray or by immersion prior to contact of the reducing agent solution. The concentration of that solution can range from about 0.05% to about 5%, with a preferred range of about 0.1% to about 2.5%. Generally no pH adjustment of the solution is required. The neutralizing solution may contain a food-grade wetting agent and effective amounts of a food-grade thickener, to respectively facilitate tissue contact and enhance the residence time of the solution on the tissue.

These and other aspects of the invention are described further in the detailed description of the invention.

### DETAILED DESCRIPTION OF THE INVENTION

As used herein, the following terms have the following respective meanings.

“Meat” includes any ingestable flesh of a mammalian, avian, reptilian, or fish origin. Meat therefore includes but is not limited to tissue derived from cattle, porcine, poultry, ruminant (e.g., horse, bison, and deer), and fish sources.

“Reducing agents” include any food-acceptable reducing agents, including but not limited to Vitamin C (ascorbic acid), ascorbic acid salts such as sodium or calcium ascorbate, ascorbic acid esters such as ascorbyl palmitate, erythorbic acid, sodium or potassium bisulfite, sodium or potassium metabisulfite, and sodium thiosulfate.

“Neutralizer spray solution” is used synonymously with “aqueous solution comprising a reducing agent”.

In accordance with the instant invention, adverse organoleptic skin effects resulting from the exposure of animal carcasses, and sections thereof, to oxidizing germicides during processing, can be mitigated or eliminated by subsequent contact of that tissue with a food-safe reducing agent. Ordinarily the discoloration of animal tissue exposed to oxidizing antimicrobial agents does not take place immediately, but is observable after many minutes. Before this discoloration takes place, if the tissue is subsequently contacted by the reducing agent within that period of time, much or all of the discoloration will not occur. Generally, the closer in time of the exposure to the original antimicrobial treatment, the lesser the discoloration. It is also preferred to apply a water rinse to the antimicrobial-treated tissue prior to contact with the reducing agent so as to remove residual antimicrobial oxidant. The contact with the color-protecting agent can be made by immersion of the tissue in a solution of the agent, or by a spray application thereof. In a further finding, where initial discoloration may take place from using high levels of, and/or prolonged contact of the tissue with oxidizing germicides, the discoloration may later be substantially reduced or eliminated.

Color changes are believed to occur because oxidizing species can penetrate cell walls, where the changes can result from the oxidation of blood hemoglobin to methemoglobin, the oxidation of carotenoid colorants in animal fat, and/or the oxidation of the amino acids tyrosine and tryptophan in tissue proteins. Additional untoward effects include bleaching of the skin, especially on the wings and breasts of poultry carcasses, and pale brownish colors formed on neck skin. In red meat animals, the predominant effect is from oxidation of hemoglobin, where it was found during the course of these studies that pork meat is less susceptible to oxidative changes than beef tissue. When some discoloration of treated tissue does develop through contact by oxidizing germicides, even after having been exposed to the inventive neutralizers, it has been found that much of the red hemoglobin color which had been adversely affected within minutes of treatment can re-appear after several hours of storage, even under refrigerated conditions. This surprising finding strongly suggests that the discoloration of hemoglobin involves only tissue cells near the surface of the treated meat, and that with passing time the intact hemoglobin in underlying cells can re-equilibrate with surface cellular hemoglobin, to displace or dilute the oxidized, methemoglobin pigment. Thus animal tissue that does show temporary discoloration is less of a concern, based on the knowledge that its adverse color can revert to approximate its original color before the disinfected tissue leaves the processing plant, or is subsequently further processed.

The neutralizing solution of the invention may be contacted with the meat product that had been treated with an oxidizing germicide, preferably following a water wash processing step. In one illustrative example, the neutralizing solution would be introduced as a final step in one or several of the standard methods for disinfecting poultry carcasses or poultry carcass pieces: This could be, for example, after first washing the carcass after evisceration, spraying with the germicide, rinsing with water, spraying with the neutralizer, allowing the solution to drip, and then immersing in the chiller tank. Or a spray of the neutralizer can be applied to the carcass after removal from a chiller tank containing an oxidizing germicide, and allowing the excess neutralizer solution to drip off. Alternatively, the neutralizing solution can be applied after both of the above sequential operations. The neutralizing solution can also be applied to carcass pieces that have been separated and treated (by dip or spray) with an oxidizing germicide, by spraying or dipping in the neutralizer solution.

For use on red meat tissue, the neutralizer spray solution could be applied after any or every stage in which an oxidizing germicide had been applied, preferably after first rinsing off excess residues of germicide after an appropriate time period. The latter would be determined by microbiological evaluation of the animal tissue after various exposure time periods, prior to removal of the germicide with a water wash. When further residence of the germicide on the animal tissues brings about no further reduction of organism levels, the neutralizer solution would then be applied.

Studies should be run to determine whether higher contact times or oxidizing germicide levels bring about greater reductions of unwanted surface organisms, irrespective of the occurrence of adverse organoleptic effects. Such studies should be repeated wherein the neutralizer solution is applied after germicide contact times, or concentrations, that would ordinarily be detrimental to tissue quality. Observations are then conducted on tissue quality, both within say 30 minutes of neutralizer use and after say 6 hours, when stored under refrigeration. An extension of initial acceptable surface qualities, or a reversion to such qualities after such storage, will generally correlate with increased destruction of unwanted surface organisms. An individual practitioner skilled in the art of establishing processing plant disinfection protocols should be capable of determining the proper conditions for incorporating this inventive method into the plant operation.

Suitable food-grade neutralizing agents for use in this inventive method include ascorbic acid, its salts such as sodium or calcium ascorbate, its esters such as ascorbyl palmitate, and its isomeric erythorbic acid, as well as the alkali metal bisulfites, metabisulfites, and thiosulfates. The sodium and potassium salts of these anions are particularly preferred. The concentrations of the neutralizer solutions depend on the particular parameters of application, including primarily the nature and concentration of the oxidizing germicide. The latter category includes chlorine, chlorine dioxide, peracetic acid, ozone, acidified sodium chlorite (i.e., partially converted to chlorous acid) and acidified sodium nitrite (i.e., partially converted to nitrous acid). The concentration of the neutralizing solution can range from about 0.05% to about 5%, with a preferred range of about 0.1% to about 2.5%. The time of application to the tissue, following application of the germicide, can best be determined by a series of trials, as described above, to optimize disinfection while minimizing discoloration.

A food-grade wetting agent such as an alkylphenoxypoly(ethylene oxide), a poly(ethylene oxide/propylene oxide) block copolymer, an alkylbenzene sulfonic acid, a dioctylsulfosuccinate, and mixtures of these may be added to the solution to facilitate contact with the meat surfaces. The solution may also contain effective amounts of a food-grade thickener, preferably one sufficient to achieve a final solution viscosity of from about 5 cps to about 50 cps at room temperature, for spray applications.

The neutralizer solution can be applied to the whole or subdivided carcass parts by spray application or by immersion of the tissue in the solution in an appropriate container. It is obvious that disinfectants which have been applied as sprays to large carcass sections, such as the sides of beef, can be best neutralized by comparable sprays of the neutralizer. In general the method of application of the neutralizing reducing agent solution will parallel the method of application of the disinfecting solution, with an appropriate delay between the two applications. It is preferable that, after the disinfecting solution has been applied to the tissue, a water spray is applied at some subsequent time, prior to applying the neutralizer, so as to ensure more efficient use of the neutralizer. Without such rinsing, a more highly concentrated solution of the neutralizer would be needed, which would also be an economic burden on the processing operation. The time delay between the two applications, i.e., disinfectant and neutralizer, is best determined by an appropriate series of trials, as would be obvious to those skilled in the art of processing plant technology, and the microbiology thereof.

When discoloration of treated tissue does develop, much of the red hemoglobin color can re-appear after several hours of storage, even under refrigerated conditions. This surprising finding strongly suggests that the discoloration of hemoglobin involves only tissue cells near the surface of the treated meat, and that with passing time the intact hemoglobin in underlying cells can re-equilibrate with surface cellular hemoglobin, to displace or dilute the oxidized, methemoglobin pigment. Thus animal tissue that does show temporary discoloration is less of a concern, based on the knowledge that its adverse color can revert before the disinfected tissue leaves the processing plant, or is subsequently further processed. It has been further discovered that certain animal tissue is more susceptible to discoloration than others. Specifically poultry carcasses, particularly in the areas covered by skin, have less of a tendency to discolor than does mammalian tissue. Among the latter, pork tissue shows less discoloration tendency than does beef tissue, when exposed to similar concentrations of disinfectant and subsequent neutralizer, under parallel conditions.

The invention is described further in the following examples, which are illustrative and in no way limiting.

### EXAMPLE 1

This example illustrates the protective effect of an ascorbic acid dip following the immersion of three strips of beef, measuring 1 inch×2 inch, into an acidified sodium nitrite solution. A fourth strip was immersed in water, for control. The nitrite concentration of the disinfecting solution was 0.10% and it was adjusted to pH 3.25 with phosphoric acid. The three test pieces were immersed in the oxidant solution for 5 seconds, and removed, while the control piece was exposed for a similar time to the water. After immersion, the test pieces were then immersed in a cool water rinse for another 5 seconds, and shaken, to remove excess acidified nitrite solution. One of the test pieces was then subjected to no further processing, while the other two were immersed in a 2.0% aqueous solution of ascorbic acid for either 5 seconds or 5 minutes.

One hour later, after the oxidative effects appeared to be at a maximum level, photographs were taken of all four pieces, and their visual appearances were recorded as described in Table 1:

TABLE 1
Observations on Acidified Nitrite-Disinfected Beef
following Exposure to Water/Water followed by
2% Ascorbic Acid Solutions for 5 Seconds or 5 Minutes
(Observations made one hour post-treatment)

| Treatment | Observation |
|---|---|
| Control Water, 5 seconds | bright red, fresh beef color |
| Acidified Nitrite, 5-sec. dip; water rinse | brown color on the tissue |
| Acidified Nitrite, 5-sec. dip; water rinse; | darker red/brown color |
| 5-sec. in 2% ascorbic | |
| Acidified Nitrite, 5-sec. dip; water rinse; | dull red color |
| 5-min. in 2% ascorbic | |

This example demonstrates that exposure to the reducing agent-ascorbic acid (Vitamin C)— is capable of reducing the oxidative impact of a 0.1% nitrous acid disinfecting dip. The briefer, 5 second exposure to the neutralizing “C” solution, while effective, was less effective than the 5 minute exposure, which provided a meat color almost equivalent to the control piece color, though duller.

### EXAMPLE 2

This example illustrates the protective effect of the above series of ascorbic acid dips, when the samples are maintained under refrigeration for an additional three hours, for a total of four hours after disinfection and subsequent neutralization of the oxidizer residuals. The following Table 2 summarizes the appearance of the identical pieces after that elapsed time period.

TABLE 2
Observations on Acidified Nitrite-Disinfected Beef
following Exposure to Water/Water followed by
2% Ascorbic Acid Solutions for 5 Seconds or 5 Minutes
(Observations made four hours post-treatment)

| Treatment | Observation |
|---|---|
| Control Water, 5 seconds | bright red, fresh beef color |
| Acidified Nitrite, 5-sec. dip; water rinse | brown, slight red color |
| Acidified Nitrite, 5-sec. dip; water rinse; | bright red, fresh beef color |
| 5-sec. in 2% ascorbic | |
| Acidified Nitrite, 5-sec. dip; water rinse; | bright red, fresh beef color |
| 5-min. in 2% ascorbic | |

This example demonstrates' that the adverse color effects, caused by the oxidation of hemoglobin in the surface layers of beef that has been disinfected with an acidified nitrite solution, can be fully overcome by allowing the exposed beef to remain under refrigeration for 4 hours (for this set of conditions). Apparently the impact of the oxidant is only made on cells near the surface of the beef, and a dynamic re-equilibration of the hemoglobin in underlying cells recharges the color in the surface cells. As a result, the use of stronger-than-obvious disinfecting solutions may be feasible, since processed beef invariably remains in processing facilities or in transit for short time periods after processing

### EXAMPLE 3

This example illustrates the protective effect of a follow-up ascorbic acid dip soon after the immersion of two strips of beef, measuring ca. 1 inch×2 inch, into an acidified chlorite solution. A third strip was immersed in water, for control. The sodium chlorite concentration of the disinfecting solution was 0.1165% and it was adjusted to pH 2.55 with phosphoric acid. The two test pieces were immersed in the oxidant solution for 5 seconds, and removed, while the control piece was exposed for a similar time to the water. After immersion, the test pieces were then dipped into a cool water rinse for another 5 seconds, and shaken, to remove excess acidified chlorite solution. One of the test pieces was then subjected to no further processing, while the other was immersed in a 2.0% aqueous solution of ascorbic acid for 5 minutes.

One hour later, after the oxidative effects seemed to be at a maximum, photographs were taken of the three pieces, and their visual appearances were recorded. The results are set forth in Table 3.

TABLE 3
Observations on Acidified Chlorite-Disinfected Beef
following Exposure to Water/Water followed by
2% Ascorbic Acid Solutions for 5 Minutes
(Observations made one hour post-treatment)

| Treatment | Observation |
|---|---|
| Control Water, 5 seconds | bright red, fresh beef color |
| Acidified Chlorite, 5-sec. dip; water rinse | brown, slight red color |
| Acidified Chlorite, 5-sec. dip; water rinse; | bright red, fresh beef color |
| 5-min. in 2% ascorbic | |

This example demonstrates that exposure to the reducing agent, ascorbic acid (Vitamin C) is capable of completely reducing the oxidative impact on beef hemoglobin of a 0.1165% acidified sodium chlorite disinfecting treatment.

### EXAMPLE 4

This example illustrates how pork tissue that has been exposed to a high concentration of acidified nitrite disinfecting solution can be completely protected from discoloration by subsequent contact with a spray of an erythorbic acid solution, with no intervening water rinse. Two pieces of pork, measuring about 3 cm×5 cm, were immersed in a solution of 1563 ppm of sodium nitrite and 2200 ppm of malic acid, in which they remained for 30 seconds. Thereafter both pieces were removed from the solution, where one was immediately sprayed with a 0.5% solution of erythorbic acid for 5 seconds, from top to bottom, while the other piece was sprayed with water in the same manner. After 1 hour, the following observations set forth in Table 4 were made:

TABLE 4
Protective Effect of Erythorbic Acid Spray on Pork Tissue
Exposed to an Acidified Nitrite Disinfectant

| EXPOSURE | OBSERVATION |
|---|---|
| Immersed in Disinfectant; then water | brown tissue, yellowed fat |
| wash only [Control} | |
| Immersed in Disinfectant; then | normal pink tissue and white fat |
| erythorbic acid spray | |

A 30-second immersion in an acidified nitrite solution of the composition is very effective in destroying high levels of bacterial contaminants, so that the spray with erythorbic acid is an effective way of preserving the visual appearance of the disinfected meat. Pork tissue is apparently more readily protected from discoloration than is beef tissue, although the earlier Examples demonstrate that beef color, from similar oxidizing disinfectants, can also be ameliorated by exposure to a solution of an acceptable food chemical, reducing agent.

### EXAMPLE 5

This example demonstrates that the reducing agent sodium thiosulfate is capable of preserving the color of chicken tissue that has been exposed to the two oxidizing disinfectants 1) acidified sodium chlorite, and 2) acidified sodium nitrite. Both solutions were freshly prepared to contain 1165 ppm of the sodium salt, where the acidified sodium chlorite solution was adjusted to pH 2.5 using phosphoric acid, while the acidified sodium nitrite solution was similarly adjusted with phosphoric acid, to pH 3.5. Six chicken legs were used in this study, consisting of two sets of three, where in each set one leg was exposed to a water dip alone, one was immersed in the disinfecting solution for one minute, and one was immersed for two minutes. All six legs were then dipped quickly into fresh water and hung to drip. After one or two minutes, one of each disinfected chicken leg was dipped into a 0.5% solution of sodium thiosulfate, where they remained for 10 seconds. Each control leg for each disinfectant was dipped in water, after two minutes, for the same time period. The following visual observations set forth in Table 5 were made after 30 minutes.

TABLE 5
Protective Effect of Sodium Thiosulfate Spray following Disinfection
of Poultry Parts with Acidified Sodium Chlorite or Nitrite Solutions

| | |
|---|---|
| TREATMENT | OBSERVATION |

Acidified Sodium Chlorite Solution (1165 ppm; pH 2.5)

| | |
|---|---|
| Water dip alone (Control) | Normal colors; pink tissue, |
| | yellow fat |
| Disinfectant for 1 min., then 10 sec. | Slight gray tissue, |
| dip in Na₂S₂O₃ | otherwise acceptable |
| Disinfectant for 2 min., then 10 sec. | Brown spots, bleached |
| dip in Na₂S₂O₃ | skin, unacceptable |

Acidified Sodium Nitrite Solution (1165 ppm; pH 3.5)

| | |
|---|---|
| Water dip alone (Control) | Normal colors; pink tissue, |
| | yellow fat |
| Disinfectant for 1 min., then 10 sec. | Normal colors; pink tissue, |
| dip in Na₂S₂O₃ | yellow fat |
| Disinfectant for 2 min., then 10 sec. | Normal colors; pink tissue, |
| dip in Na₂S₂O₃ | yellow fat |

Earlier observations showed that exposure of chicken legs to these solutions induced undesirable changes in the tissues in some cases, where a 1-minute exposure to the acidified sodium chlorite solution caused an unacceptable appearance comparable to that of the 2-minute neutralization observation above, and where a 2-minute exposure to the acidified nitrite solutions caused a somewhat bleached appearance which made the chicken to be of borderline acceptability. Thus the thiosulfate neutralizer facilitates the use of higher concentrations and/or longer exposures of poultry tissue to oxidizing disinfectants, with the intrinsic benefit of higher microbial destruction.

What is claimed is:

1. A method comprising applying an aqueous solution comprising a reducing agent to meat disinfected with an oxidizing germicide, wherein application of the aqueous solution to the meat reduces meat discoloration caused by the oxidizing germicide.

2. A method of claim 1, wherein the reducing agent is selected from the group consisting of ascorbic acid, ascorbic acid salts, ascorbic acid esters, erythorbic acid, alkali metal bisulfites, metabisulfites, and thiosulfates.

3. A method of claim 1, wherein the concentration of reducing agent in the aqueous solution is between about 0.05% to about 5% by weight.

4. A method of claim 1, wherein the concentration of reducing agent in the aqueous solution is between about 0.1% to about 2.5%.

5. A method of claim 1, wherein the oxidizing germicide is selected from the group consisting of chlorine, chlorine dioxide, peracetic acid, ozone, acidified sodium chlorite and acidified sodium nitrite.

6. A method of claim 1 wherein the aqueous solution is applied to the disinfected meat between about five seconds to one hour after application of the oxidizing germicide to the meat.

7. A method of claim 1, where a water rinse is applied to the disinfected meat before application of the aqueous solution.

8. A method of claim 1, wherein the aqueous solution is sprayed on the meat.

9. A method of claim 1, wherein the disinfected meat is immersed in the aqueous solution.

10. A method of claim 1, wherein the aqueous solution further comprises a wetting agent.

11. A method of claim 1, wherein the aqueous solution further comprises a thickener.

12. A method comprising reducing discoloration of meat treated with an oxidizing germicide by contacting the meat, at a time period of between about five seconds to about one hour after germicide application, with an aqueous solution comprising a reducing agent.

13. A method claim 12, wherein the meat treated with an oxidizing germicide is subjected to a water rinse before contacting the meat with the aqueous solution comprising a reducing agent.

14. A method of claim 1, wherein the meat treated with an oxidizing germicide is sequentially sprayed with, or dipped into, the aqueous solution comprising a reducing agent.

15. A method of claim 12, wherein the meat treated with an oxidizing germicide is sequentially sprayed with, or dipped into, the aqueous solution comprising a reducing agent.
